(19) United States
(12) Patent Application Publication
(10) Pub. No.: US 2012/0113444 A1
(43) Pub. Date: May 10, 2012

(54) PRINTING APPARATUS, COLOR CONVERSION METHOD, PROGRAM, AND RECORDING MEDIUM

(75) Inventors: Seishin YOSHIDA, Azumino-shi (JP); Mitsuhiro YAMASHITA, Matsumoto-shi (JP)

(73) Assignee: SEIKO EPSON CORPORATION, Tokyo (JP)

(21) Appl. No.: 13/290,378

(22) Filed: Nov. 7, 2011

(30) Foreign Application Priority Data
Nov. 10, 2010 (JP) 2010-252210

(51) Int. Cl. H04N 1/60

(52) U.S. Cl. 358/1.9

(57) ABSTRACT

The printing apparatus is a printing apparatus which prints an image by forming a layer containing a colorant on a recording medium having luster, and is provided with a color conversion unit which converts a color of an image into a printed color expressed by the colorant such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image.

Priority is claimed under 35 U.C.S. §119 to Japanese Application No. 2010-252210 filed on Nov. 10, 2010 which is hereby incorporated by reference in its entirety.

### BACKGROUND

1. Technical Field

The present invention relates to printing on a recording medium having luster.

2. Related Art

In the related art, a technique for printing an image by discharging color ink (for example, cyan (C), magenta (M), yellow (Y), and black (K)) onto a recording medium with metallic luster. For example, a technique in which color ink is discharged on an aluminum foil sheet (foil) with the use of an ink-jet printer (JP-A-2010-94852) and a technique in which color ink is discharged onto an aluminum deposited sheet (JP-A-9-169159) have been proposed.

According to the technique for printing an image by discharging color ink onto a recording medium with metallic luster, a luster expressing effect (a glittering effect) of a base is felt to be relatively high in a bright region where the amount of the color ink is relatively small (highlighted region) when a color image is printed on an aluminum deposited sheet with the use of an ink-jet printer, for example. Therefore, it becomes difficult to visually recognize the color of a color ink layer due to such a luster expressing effect. In addition, a degree of change in brightness and saturation (gradation reproducibility) with respect to the gradation change of pixels is lowered. Moreover, there is a problem in that the increasing degree of the brightness is lowered and the gradation reproducibility is lowered in the highlighted region even if the amount of the color ink is lowered since the brightness of the aluminum deposited sheet itself as the base is relatively low (dark).

The above problem is not a problem only in the recording medium with the metallic luster but a common problem for an arbitrary recording medium expressing the sense of luster (recording medium having luster) such as a recording medium with luster similar to the pearly luster or the like, for example. In addition, the above problem is not a problem only in an ink-jet printer but a common problem in various printing apparatuses which form a color ink layer (a layer containing a colorant) on a recording medium having luster for printing, such as an offset printing machine and the like.

### SUMMARY

An advantage of some aspect of the invention is to suppress lowering in the gradation reproducibility in a highlighted region of an image when a layer containing a colorant is formed on a recording medium having luster with the use of a printing apparatus.

The invention was made to solve at least a part of the above problem and can be realized as the following embodiments or the applications.

### Application 1

According to an aspect of the invention, there is provided a printing apparatus which prints an image by forming a layer containing a colorant on a recording medium having luster, including: a color conversion unit which converts a color of an image into a printed color expressed by the colorant such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image.

According to the printing apparatus of the application 1, a color of an image is converted into a printed color such that a degree of change in brightness with respect to a gradation change for pixels belonging to a highlighted part in which index values relating to the brightness are equal to or greater than a first predetermined value is greater than that for pixels which do not belong to the highlighted part. Therefore, it is possible to set the degree of change in brightness with respect to the gradation degree to be high in the highlighted region of the image. For this reason, it is possible to suppress lowering of gradation reproducibility in the highlighted region in the obtained image when an image is printed by forming a layer containing a colorant on a recording medium having luster according to the printing apparatus of the application 1.

### Application 2

In the printing apparatus of the application 1, the color conversion unit converts the color of the image into the printed color with the use of a color conversion LUT which sets the degree of change in brightness with respect to the gradation change for the pixels with the index values which belong to the highlighted part to be larger than that for the pixels with the index values which do not belong to the highlighted region, among the pixels constituting the image.

With such a configuration, it is possible to convert the color of the image into the printed color such that the degree of change in brightness with respect to the gradation change for the pixels with the index values which belong to the highlighted part is larger than that for the pixels with the index values which do not belong to the highlighted part by performing the color conversion with the use of the color conversion LUT. In addition, the color conversion LUT is set in advance so as to convert the color of the image into the printed color such that the degree of change in brightness with respect to the gradation change for the pixels with index values which belong to the highlighted part is larger than that for the pixels with the index values which do not belong to the highlighted part. Therefore, it is not necessary to adjust the degree of change in brightness with respect to the gradation change for the pixels constituting an image every time an image is printed, and thereby to shorten the time required for printing.

### Application 3

In the printing apparatus of the application 1, the color conversion unit includes: a brightness adjustment unit which sets the degree of change in brightness with respect to the gradation change for the pixels with index values which belong to the highlighted region to be larger than that for the pixels with index values which do not belong to the highlighted region, among the pixels constituting the image; a color conversion LUT which associates the color of the image with the printed color; and a conversion unit which converts the color of the image which has been adjusted by the brightness conversion unit into the printed color with the use of the color conversion LUT.

With such a configuration, it is possible to convert the color of the image into the printed color such that the degree of change in brightness with respect to the gradation change for the pixels with index values which belong to the highlighted part is larger than that for pixels with index values which do not belong to the highlighted part. In addition, it is possible to use an existing LUT for the printing apparatus, in which the degree of change in brightness with respect to the gradation change has not been adjusted, as the color conversion LUT. Therefore, it is possible to easily update the LUT when the LUT is updated.

### Application 4

According to another aspect of the invention, there is provided a printing apparatus which prints an image by forming a layer containing a colorant on a recording medium having luster, including: a color conversion unit which converts a color of an image into a printed color expressed by the colorant such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image. According to the printing apparatus of the application 4, the color of the image is converted into the printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part. Therefore, it is possible to increase the degree of change in saturation with respect to the gradation change in the highlighted region of the image. The pixels with the index values which belong to the highlighted part, whose saturation is equal to or less than a predetermined value, are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when an image is printed by forming a layer containing a colorant on a recording medium having luster according to the printing apparatus of the application 4.

### Application 5

In the printing apparatus of the application 4, the color conversion unit converts the color of the image into the printed color with the use of a color conversion LUT which sets the degree of change in saturation with respect to the gradation change for the low saturation pixels to be larger than that for the pixels with the index values which do not belong to the highlighted region, among the pixels constituting the image.

With such a configuration, it is possible to convert the color of the image into the printed color such that the degree of change in saturation with respect to the gradation change for the low saturation pixels is larger than that for the pixels with the index values which do not belong to the highlighted part by performing the color conversion with the use of the color conversion LUT. In addition, the color conversion LUT is set in advance so as to convert the color of the image into the printed color such that the degree of change in saturation with respect to the gradation change for the low saturation pixels is larger than that for the pixels with the index values which do not belong to the highlighted part. Therefore, it is not necessary to adjust the degree of change in saturation with respect to the gradation change for the pixels constituting an image every time an image is printed, and thereby to shorten the time required for printing.

### Application 6

In the printing apparatus of the application 4, the color conversion unit includes: a saturation adjustment unit which sets the degree of change in saturation with respect to the gradation change for the low saturation pixels to be larger than that for the pixels with index values which do not belong to the highlighted region, among the pixels constituting the image; a color conversion LUT which associates the color of the image with the printed color; and a conversion unit which converts the color of the image which has been adjusted by the saturation adjustment unit into the printed color with the use of the color conversion LUT.

With such a configuration, it is possible to convert the color of the image into the printed color such that the degree of change in saturation with respect to the gradation change for the pixels with index values which belong to the highlighted part is larger than that for pixels with index values which do not belong to the highlighted part. In addition, it is possible to use an existing LUT for the printing apparatus, in which the degree of change in saturation with respect to the gradation change has not been adjusted, as the color conversion LUT. Therefore, it is possible to easily update the LUT when the LUT is updated.

### Application 7

According to still another aspect of the invention, there is provided a printing control apparatus which controls a printing apparatus which prints an image by forming a layer containing a colorant on a recording medium having luster, the printing control apparatus including: a color conversion unit which converts a color of an image into a printed color expressed by the colorant such that a degree of change in brightness with respect to a gradation change for pixels belonging to a highlighted part in which index values relating to the brightness are equal to or greater than a first predetermined value is greater than that for pixels with index values which do not belong to the highlighted part, among the pixels constituting the image.

In the printing control apparatus of the application 7, the color of the image is converted into the printed color such that the degree of change in brightness with respect to the gradation change for the pixels belonging to the highlighted part in which the index values relating to brightness are equal to or greater than the predetermined value, is larger than that for the pixels which do not belong to the highlighted part. Therefore, it is possible to increase the degree of change in brightness with respect to the gradation change in the highlighted region of the image. For this reason, it is possible to suppress the lowering of the gradation reproducibility in the highlighted region of the obtained image when the image is printed by forming a layer containing the colorant on the recording medium having luster according to the printing control apparatus of the application 7.

### Application 8

According to still another aspect of the invention, there is provided a printing control apparatus which controls a printing apparatus which prints an image by forming a layer containing a colorant on a recording medium having luster, the printing control apparatus including: a color conversion unit which converts a color of an image into a printed color expressed by the colorant such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image.

According to the printing control apparatus of the application 8, the color of the image is converted into the printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part. Therefore, it is possible to increase the degree of change in saturation with respect to the gradation change in the highlighted region of the image. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when the image is printed by forming a layer containing the colorant on the recording medium having luster according to the printing control apparatus of the application 8.

### Application 9

According to still another aspect of the invention, there is provided a color conversion method by which a color of an image is converted into a printed color expressed by a colorant used in a printing apparatus, the method including: converting a color of an image into a printed such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image, wherein the printing apparatus is capable of printing the image by forming a layer containing the colorant on a recording medium having luster.

In the color conversion method of the application 9, the color of the image is converted into the printed color such that the degree of change in brightness with respect to the gradation change for the pixels belonging to the highlighted part in which the index values relating to brightness are equal to or greater than the predetermined value, is larger than that for the pixels which do not belong to the highlighted part. Therefore, it is possible to increase the degree of change in brightness with respect to the gradation change in the highlighted region of the image printed by the printing apparatus. For this reason, it is possible to suppress the lowering of the gradation reproducibility in the highlighted region of the obtained image when the image is printed by forming a layer containing the colorant on the recording medium having luster with the use of the printing apparatus according to the color conversion method of the application 9.

### Application 10

According to still another aspect of the invention, there is provided a color conversion method by which a color of an image is converted into a printed color expressed by a colorant used in a printing apparatus, the method including: converting a color of an image into a printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image, wherein the printing apparatus is capable of printing the image by forming a layer containing the colorant on a recording medium having luster.

In the color conversion method of the application 10, the color of the image is converted into the printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part. Therefore, it is possible to increase the degree of change in saturation with respect to the gradation change in the highlighted region of the image printed by the printing apparatus. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained when an image is printed by forming a layer containing the colorant on a recording medium having luster with the use of the printing apparatus according to the color conversion method of the application 10.

### Application 11

According to still another aspect of the invention, there is provided a program by which a color of an image is converted into a printed color expressed by a colorant used in a printing apparatus, the program causing a computer to execute: converting a color of an image into a printed color such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image, wherein the printing apparatus is capable of printing the image by forming a layer containing the colorant on a recording medium having luster.

According to the program of the application 11, the color of the image is converted into the printed color such that the degree of change in brightness with respect to the gradation change for the pixels belonging to the highlighted part in which the index values relating to brightness are equal to or greater than the predetermined value, is larger than that for the pixels which do not belong to the highlighted part. Therefore, it is possible to increase the degree of change in brightness with respect to the gradation change in the highlighted region of the image printed by the printing apparatus. For this reason, it is possible to suppress the lowering of the gradation reproducibility in the highlighted region of the obtained image when an image is printed by forming a layer containing the colorant on a recording medium having luster with the use of the printing apparatus according to the program of the application 11.

### Application 12

According to still another aspect of the invention, there is provided a program by which a color of an image is converted into a printed color expressed by a colorant used in a printing apparatus, the program causing a computer to execute: converting a color of an image into a printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image, wherein the printing apparatus is capable of printing the image by forming a layer containing the colorant on a recording medium having luster.

According to the program of the application 12, the color of the image is converted into the printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part. Therefore, it is possible to increase the degree of change in saturation with respect to the gradation change in the highlighted region of the image printed by the printing apparatus. The pixels with the index values which belong to the highlighted part, whose saturation is equal to or less than a predetermined value (low saturation pixels), are pixels representing relatively bright image regions with a faint color. It is difficult to recognize the gradation change of the pixels with a faint color due to the low vividness. Accordingly, it is possible to suppress the lowering of gradation reproducibility in the highlighted region of the obtained image when an image is printed by forming a layer containing the colorant on a recording medium having luster with the use of the printing apparatus according to the program of the application 12.

### Application 13

According to still another aspect of the invention, there is provided a computer readable recording medium which records the program of the application 11 or 12.

With such a configuration, it is possible to cause a computer to read the program and realize each function with the use of such a recording medium.

In addition, the invention can be realized in various manners such as in color conversion LUT, a color conversion LUT generating method, a computer program for LUT generation, a recording medium recording the computer program thereon, and the like.

### BRIEF DESCRIPTION OF THE DRAWINGS

The invention will be described with reference to the accompanying drawings, wherein like numbers reference like elements.

FIG. 1 is a configuration diagram schematically showing a printer as an embodiment of the invention.

FIG. 2 is a flowchart of printing processing in the embodiment.

FIG. 3 is a flowchart showing a procedure of producing a LUT shown in FIG. 1.

FIG. 4 is an explanatory diagram schematically showing contents of setting of a brightness adjustment LUT shown in FIG. 1.

FIG. 5 is an explanatory diagram showing a procedure of printing processing according to a second embodiment.

FIG. 6 is a configuration diagram schematically showing a printer according to a third embodiment.

FIG. 7 is a flowchart showing a procedure of second LUT producing processing according to the third embodiment.

FIG. 8 is an explanatory diagram showing contents of setting of a saturation adjustment LUT shown in FIG. 6.

FIG. 9 is a flowchart of printing processing according to the third embodiment.

FIG. 10 is an explanatory diagram showing an application of the invention to a computer according to a modified example 8.

### DESCRIPTION OF EXEMPLARY EMBODIMENTS

### A. First Embodiment

### A1. Configuration of Printing Apparatus

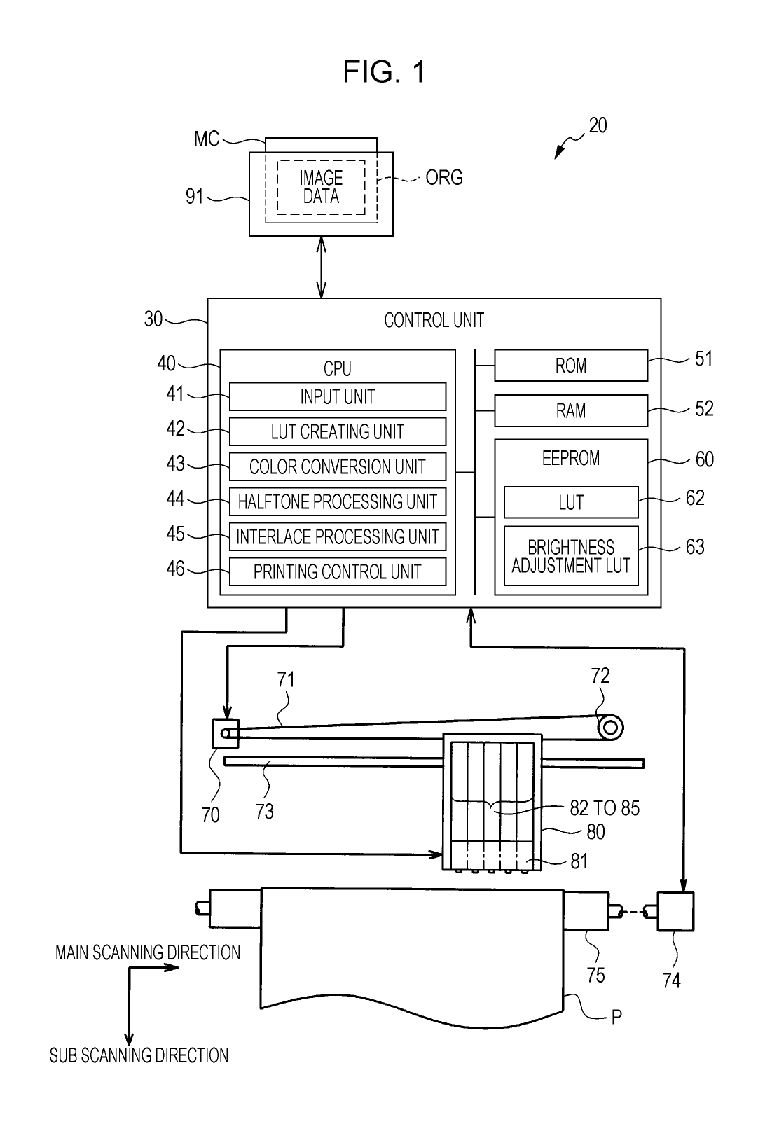

FIG. 1 is a configuration diagram schematically showing a printer according to an embodiment of the invention. A printer 20 is an ink-jet printer which prints an image by discharging color ink (cyan ink C, magenta ink M, yellow ink Y, and black ink K) onto a printing medium P. In this embodiment, the printing medium P is an aluminum deposited sheet with metallic luster on the surface thereof. In addition, the aluminum deposited sheet is manufactured by agglutinating aluminum on the surface of the sheet as the base material based on a vacuum thin-film forming method, for example.

The printer 20 is provided with a mechanism which transports the printing medium P by a sheet feeding motor 74, a mechanism which reciprocates carriage 80 in an axial direction of a platen 75 by a carriage motor 70, a mechanism which drives a print head 81 mounted on the carriage 80 to discharge ink and form dots, and a control unit 30 which manages the signal communication with the sheet feeding motor 74, the carriage motor 70, and the print head 81.

The mechanism which reciprocates the carriage 80 in the axial direction of the platen 75 is stretched so as to be parallel to the axis of the platen 75 and includes a sliding axis 73 which slidably holds the carriage 80, a pulley 72 which stretches an endless driving belt 71 to the carriage motor 70, and the like.

On the carriage 80, ink cartridges 82 to 85 for color ink, which contain cyan ink C, magenta ink M, yellow ink Y, and black ink K, respectively, are mounted. Nozzle arrays corresponding to the aforementioned each color ink are formed on the print head 81 under the carriage 80. It is possible to supply ink from each cartridge to the print head 81 by mounting such ink cartridges 82 to 85 on the carriage 80 from the upper direction.

In addition, the “color ink” in this embodiment means a concept including the black ink. Moreover, pigment ink is used as the color ink in this embodiment.

The control unit 30 has a configuration in which a CPU 40, a ROM 51, a RAM 52, and an EEPROM 60 are connected to each other via a bus. In addition, a memory card slot 91 is connected to the control unit 30. The memory card slot 91 contains a memory card MC which records image data ORG. In this embodiment, the image data ORG is data including three color components of red (R), green (G), and blue (B).

The CPU 40 develops and executes a program stored on the ROM 51 or the EEPROM 60 in the RAM 52 to function as an input unit 41, a LUT creating unit 42, a color conversion unit 43, a halftone processing unit 44, an interlace processing unit 45, and a print control unit 46.

The input unit 41 reads the image data ORG from the memory card MC inserted into the memory card slot 91. The LUT creating unit 42 executes the LUT creating processing which will be described later. The color conversion unit 43 converts the image data ORG (R, G, B) into the data of ink colors (CMYKS). The halftone processing unit 44 executes the halftone processing. The interlace processing unit 45 performs the interlace processing for rearranging the data into dot pattern data to be printed in units of one main scanning. The print control unit 46 controls the reciprocation of the carriage 80 and sheet feeding and drives the print head 81 to control the discharge of ink to the printing medium P.

The EEPROM 60 stores a look up table (LUT) 62. The LUT 62 is a table which associates the input value in the form of RGB with the output value in the form of CMYKS. In addition, the EEPROM 60 stores brightness adjustment LUT 63. In addition, the detail of the brightness adjustment LUT 63 will be described later.

The printer 20 with the hardware configuration as described above drives the carriage motor 70 to cause the print head 81 to reciprocate with respect to the printing medium P in the main scanning direction and drives the sheet feeding motor 74 to move the printing medium P in the sub scanning direction. The control unit 30 (print control unit 46) drives the nozzles at appropriate timing based on the print data in accordance with the reciprocation of the carriage 80 (main scanning direction) and the sheet feeding movement of the printing medium (sub scanning direction) to form ink dots with appropriate colors at appropriate positions on the printing medium P.

The printer 20 can suppress the lowering of the gradation reproducibility in the bright region (highlighted region) in the image when a color image is printed on the printing medium P which is an aluminum deposited sheet, by performing the color conversion with the use of the LUT 62 created in the LUT creating processing which will be described later. In addition, the aforementioned color conversion unit 43 and the LUT 62 correspond to the color conversion unit 43 in the above-described aspects. In addition, the printing medium P corresponds to the recording medium having luster in the above-described aspects.

### A2. Printing Processing

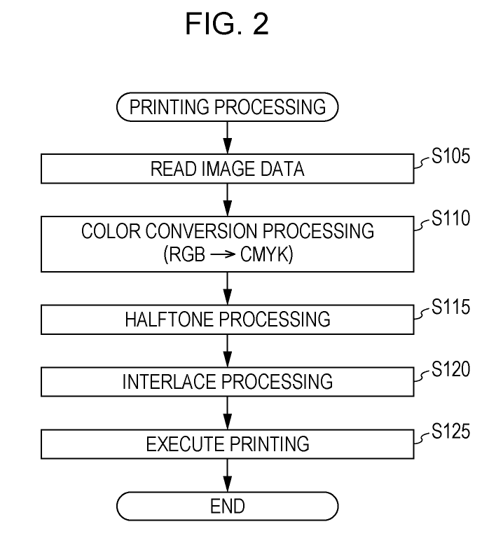

FIG. 2 is a flowchart of the printing processing according to this embodiment. When the user instructs the printing processing on the operation panel not shown in the drawing, the printing processing is started in the printer 20. The input unit 41 reads the image data ORG of the RGB format as a print target from the memory card MC via the memory card slot 91 (Step S105).

The color conversion unit 43 converts the image data ORG into the image data in the CMYK format which can be expressed by the printer 20 based on the LUT 62 stored on the EEPROM 60 (Step S110). In addition, the LUT 62 may be stored on another recording medium such as a hard disk drive provided in the printer 20, for example, which is not shown in the drawing, or may be configured to be downloaded from a computer or the like connected to the printer 20, which is not shown in the drawing.

The halftone processing unit 44 performs the halftone processing which is for converting the image data, which has been subjected to the color conversion processing, into ON/OFF data of dots of each color (Step S115). As a specific method of the halftone processing, it is possible to employ a known method such as an ordered dither method, an error diffusion method, a density pattern method, and the like, for example.

The interlace processing unit 45 performs the interlace processing (Step S120). When the interlace processing is performed, the print control unit 46 drives the carriage motor 70, the sheet feeding motor 74, and the print head 81 based on the dot pattern data, causes the print head 81 to discharge the color ink, and executes printing (Step S125).

### A3. LUT Creating Processing

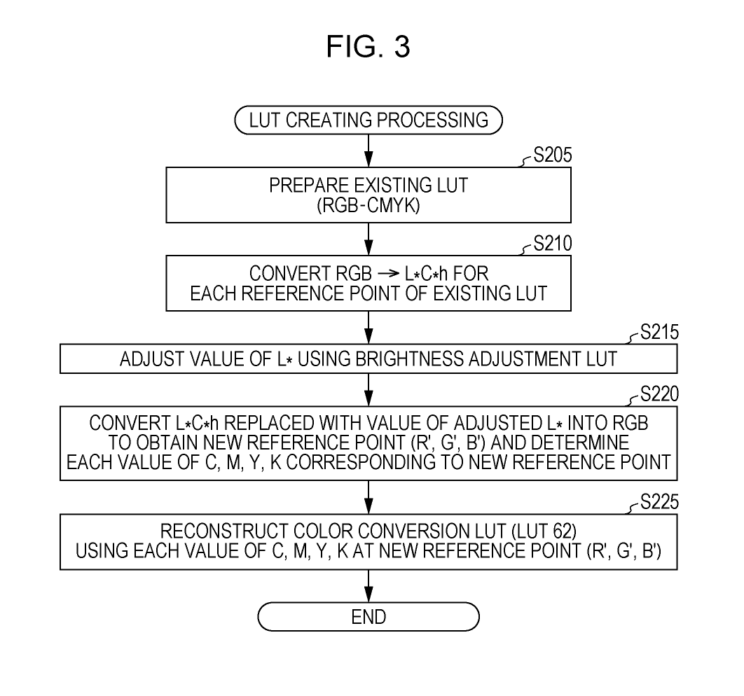

FIG. 3 is a flowchart showing a procedure of creating the LUT shown in FIG. 1. The creation of the LUT 62 can be executed before the shipping of the printer 20. Alternatively, it is also possible for a user to execute the creation of the LUT 62 at arbitrary timing at the time of initial activation of the printer 20 or after the initial activation.

First, an existing LUT for the printer 20 is prepared (Step S205). In this embodiment, the existing LUT means a LUT in which a correspondence relationship between the value in the RGB format (input value) and the value in the CMYK format (output value) is described. As such a LUT, it is possible to use a LUT in which each value of C, M, Y, K is set in association with each of seventeen reference points which are arranged at equal intervals on each axis of R, G, B, for example.

The LUT creating unit 42 converts R, G, B for each reference point in the existing LUT prepared in Step S205 (points for which the correspondence relationship between R, G, B and C, M, Y, K is defined) into L* (brightness), C* (saturation), and h (hue angle) (Step S210). Such color space conversion can be performed by a known method such as a method of converting sRGB (standard RGB) into L*C*h, a method of converting AdobeRGB into L*C*h, and the like.

The LUT creating unit 42 adjust the value of L* (brightness) of each reference point with the use of the brightness adjustment LUT 63 shown in FIG. 1 (Step S215).

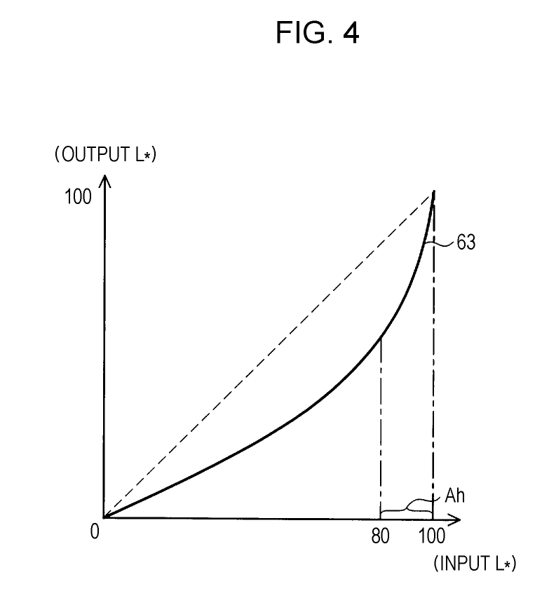

FIG. 4 is an explanatory diagram schematically showing contents of setting of the brightness adjustment LUT shown in FIG. 1. In FIG. 4, the horizontal axis represents the input value L* while the vertical axis represents the output value L*. In FIG. 4, a thick solid line schematically shows the brightness adjustment LUT 63. The brightness adjustment LUT 63 is a LUT for converting the input L* value into the output L* value.

As shown in FIG. 4, the increasing degree of the output L* value with respect to the increase in the input L* value in the highlighted part Ah (80≦L*≦100) is set to be higher than the increasing degree of the output L* value with respect to the increase in the input L* value in the region other than the highlighted part Ah in the brightness adjustment LUT 63. In addition, the increasing degree of the output L* value with respect to the increase in the input L* value is set to be higher than the increasing degree of the output L* value with respect to the increase in the input L* value before the brightness adjustment (the inclination of a straight line shown by a broken line) in the highlighted part Ah.

Next, the LUT creating unit 42 replaces L* among the values L*C*h of each reference point obtained in Step S210 with L* adjusted in Step S215, converts the replaced L*C*h into RGB to obtain a new adjusted reference point (R′, G′, B′), and determines values (amounts of ink) of C, M, Y, K corresponding to the new reference points (R′, G′, B′) (Step S220). As described above, the increasing degree of the output L* with respect to the input L* value is high in the highlighted part Ah. Therefore, the new reference point is determined such that the difference in brightness per one gradation level becomes greater for the reference point belonging to the highlighted part Ah (that is, the reference point at which the L* value satisfies 80≦L*≦100). The amounts of ink C, M, Y, K corresponding to the new reference point can be obtained by interpolating computation based on the amounts of ink at each reference point in the existing LUT, for example.

Next, the LUT creating unit 42 writes in the LUT 62 that values of C, M, Y, K at the calculated new reference point (R′, G′, B′) are to be used as amounts of ink at the reference point (R, G, B) in the color conversion LUT (LUT 62) and reconstructs the color conversion LUT (LUT 62) (Step S225).

In the thus obtained LUT 62, the differences in brightness of the ink colors (values of C, M, Y, K) associated with two adjacent reference points (that is, the differences in brightness of the ink colors per one gradation level) at the reference point belonging to the RGB color space regions corresponding to the highlighted part Ah is greater than that at the reference points belonging to the region other than the RGB color space.

If the color conversion is performed on the image in the aforementioned Step S110 with the use of such a LUT 62, the increasing degree of L* of the color obtained in the actual printing with respect to the increase in the L* value of the input pixel belonging to the highlighted part Ah (the pixels with the L* value satisfying 80≦L*≦100) becomes greater than that of the input pixel which does not belong to the highlighted part Ah. Accordingly, the gradation reproducibility is enhanced in the bright region in the printed image.

As described above, the LUT set such that the differences in brightness of the ink colors per one gradation level of the input pixel belonging to the highlighted part Ah are greater than the differences in brightness of the ink color per one gradation level of the input pixel which does not belong to the highlighted part Ah is used as the LUT 62 for color conversion in the printer 20 according to the first embodiment. Therefore, it is possible to enhance the gradation reproducibility by the color ink in the highlighted region in the printed image. Accordingly, it is possible to suppress the lowering of the gradation reproducibility in the highlighted region in the printed image even when printing is performed by forming a layer of the color ink on the printing medium P with metallic luster.

In addition, it is not necessary to adjust the LUT 62 every time the printing is performed and thereby to shorten the period necessary for printing since the LUT 62 is set in advance to enhance the gradation reproducibility by the color ink in the highlighted region.

### B. Second Embodiment

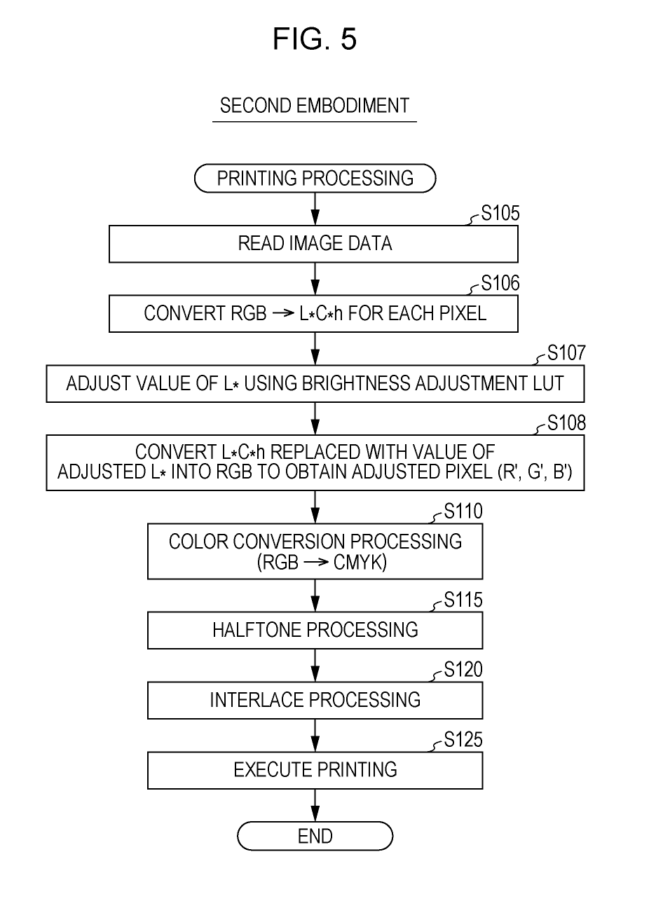

FIG. 5 is an explanatory diagram showing a procedure of printing processing according to the second embodiment. The printer of the second embodiment is different from the printer 20 shown in FIG. 1 in that Steps S106 to S108 are additionally executed in the printing processing and that the LUT 62 is an existing LUT, and the other configurations are the same as those in the first embodiment.

According to the printer 20 of the first embodiment, the gradation reproducibility by the color ink is enhanced by performing the color conversion with the use of the LUT 62 set such that the differences in brightness of the ink colors per one gradation level of the input pixel belonging to the highlighted part Ah is greater than the differences in the brightness of the ink colors per one gradation level of the input pixel which does not belong to the highlighted part Ah. On the other hand, the gradation reproducibility by the color ink is enhanced by adjusting the input image (R, G, B) in the printing processing according to the printer of the second embodiment.

Specifically, the color conversion unit 43 converts R, G, B of each pixel read in Step S105 into L* (brightness), C* (saturation), and h (hue angle) after the aforementioned processing in Step S105 in the printing processing shown in FIG. 5 (Step S106). The color space conversion can be performed by a known method.

The color conversion unit 43 adjusts the L* value of each pixel with the use of the brightness adjustment LUT 63 (Step S107). This processing is the same processing in Step S215 in the LUT creating processing according to the first embodiment. Therefore, the pixels belonging to the highlighted part Ah (pixels which satisfy 80≦L*≦100) are adjusted such that the differences in L* between pixels become greater.

The color conversion unit 43 replaces L* from among the values of L*C*h of the pixel obtained in Step S106 with L* adjusted in Step S107, converts the replaced L*C*h into RGB, and obtains the adjusted pixel (R′, G′, B′) (Step S108). This processing is the same processing in Step S220 in the LUT creating processing according to the first embodiment.

As describe above, the same processing in Steps S110 to S125 according to the first embodiment is executed as the processing after obtaining the adjusted pixel (R′, G′, B′). That is, the processing of converting the adjusted pixel (R′, G′, B′) into C, M, Y, K, the halftone processing, and the interlace processing are executed in this order, and the printing is then executed.

According to the printer of the second embodiment with the above configuration, the image data ORG is adjusted such that differences in the brightness between the pixels with different brightness, which belong to the highlighted part Ah, from among the pixels constituting the input image become greater than those between the pixels which do not belong to the highlighted part Ah, and the color conversion processing is then performed. Accordingly, it is possible to perform the color conversion such that the differences in brightness of the ink colors between the pixels with different brightness, which belong to the highlighted part Ah becomes greater than the differences in brightness of the ink colors between the pixels which do not belong to the highlighted part Ah in Step S110 (color conversion processing). Therefore, it is possible to enhance the gradation reproducibility by the color ink in the highlighted region in the printed image. In addition, since it is possible to use an existing LUT of the printer 20 as the LUT for the color conversion processing, it is possible to easily update the LUT when the LUT is updated. In other words, it is possible to update the LUT 62 without any complicated operations by storing the updated LUT, which has been manufactured by a manufacture of the printer 20, as it is on the printer 20 (EEPROM 60).

### C. Third Embodiment

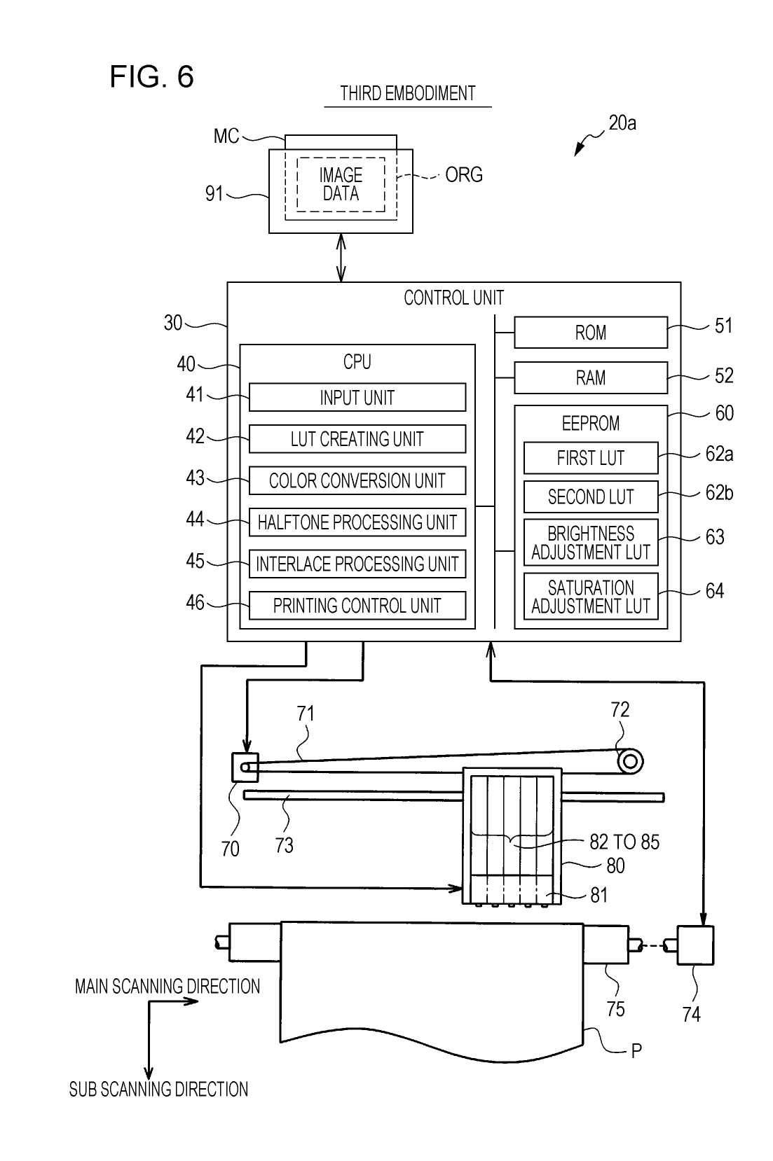

FIG. 6 is a configuration diagram schematically showing a printer according to the third embodiment. The printer 20a of the third embodiment is different from the printer 20 shown in FIG. 1 in that a first LUT 62a and a second LUT 62b are provided instead of the LUT 62, a saturation adjustment LUT 64 is additionally provided, and saturation is also adjusted (emphasized) as well as brightness in the highlighted region of the image, and the other configurations are the same as those in the first embodiment.

Both the first LUT 62a and the second LUT 62b are look up tables used in the color conversion in the printing processing. The first LUT 62a is the look up table in which the same contents as those in the LUT 62 according to the first embodiment are set. Accordingly, the first LUT 62a can be obtained in the LUT creating processing shown in FIG. 3 in the same manner as in the first embodiment. However, the first LUT 62a is used for the color conversion of the pixels which do not belong to the highlighted part Ah in the image unlike in the first embodiment, as will be described later. The second LUT 62b is used for the color conversion of the pixels which belong to the highlighted part Ah in the image. In addition, the details of the second LUT 62b will be described later.

### C1. Second LUT Creating Processing

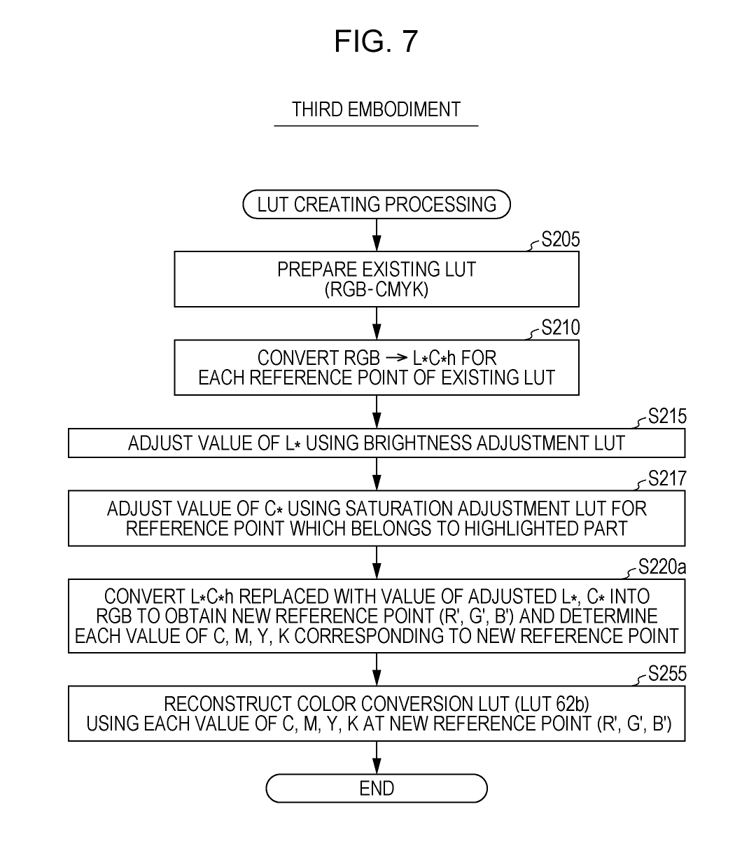

FIG. 7 is a flowchart showing a procedure of the second LUT creating processing according to the third embodiment. The LUT creating processing according to the third embodiment is different from the LUT creating processing according to the first embodiment shown in FIG. 3 in that Step S217 is additionally executed and Step S220a is executed instead of Step S220, and the other processing is the same as that in the first embodiment.

After the execution of the aforementioned Step S205 to S215, the LUT creating unit 42 adjusts the value of C* (saturation) of the reference point belonging to the highlighted part Ah (pixel whose L* value before the adjustment in Step S215 satisfies 80≦L*≦100) with the use of a saturation adjustment LUT 64 shown in FIG. 6 (Step S217).

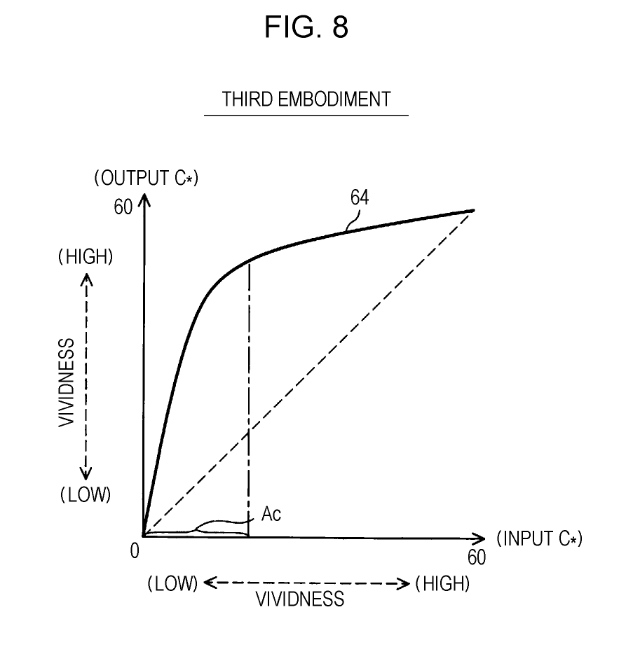

FIG. 8 is an explanatory diagram showing contents of setting of a saturation adjustment LUT shown in FIG. 6. In FIG. 8, the horizontal axis represents the input C* value while the vertical axis represents the output C* value. In FIG. 8, a thick solid line schematically shows the saturation adjustment LUT 64. The saturation adjustment LUT 64 is a LUT for converting the input C* value into the output C* value.

As shown in FIG. 8, in the saturation adjustment LUT 64, the increasing degree of the output C* value with respect to the increase in the input C* value in the low saturation part Ac (0≦C*≦20) is set to be greater than the increasing degree of the output C* value with respect to the input C* value in the region other than the low saturation part Ac. In addition, the increasing degree of the output C* value with respect to the increase in the input C* value in the low saturation part Ac is set to be greater than the increasing degree of the output C* value with respect to the increase in the input C* value before the saturation adjustment (equal to the inclination of the straight line shown by a broken line, namely an increase degree of the output C* with respect to the increase in the input C* value in the first LUT 62a).

Next, the LUT creating unit 42 replaces L* and C* among the values of L*C*h at each reference point obtained in Step S210 with L* adjusted in Step S215 and C* adjusted in Step S217 and converts L*C*h after the replacement into RGB to obtain an adjusted reference point (R′, G′, B′), namely a new reference point (Step S220a). In relation to brightness, a new reference point is determined such that the differences in brightness per one gradation level at a reference point belonging to the highlighted part Ah becomes larger since the same processing as that in the first embodiment is performed. In relation to saturation, a new reference point is determined such that the differences in saturation per one gradation level at a reference point belonging to the highlighted part Ah and the low saturation part Ac (that is, a reference point whose L* value satisfies L* 100 and C* value satisfies 0≦C*≦20) becomes greater. Here, a reference point which belongs to both the highlighted part Ah and the low saturation part Ac means a reference point corresponding to a color which is relatively bright and faint.

After obtaining a new reference point (R′, G′, B′), the aforementioned Step S225 is executed to generate the second LUT 62b. In the thus obtained second LUT 62b, the differences in the brightness of ink colors per one gradation level at reference points belonging to the RGB color space region corresponding to the highlighted part Ah are greater than those at the reference points belonging to the region other than the RGB color space in the same manner as in the first LUT 62a. In addition, the differences in saturation of the ink color per one gradation level at reference points belonging to the RGB color space region corresponding to the low saturation part Ac are greater than those at the reference points belonging to the region other than the RGB color space.

### C2. Printing Processing

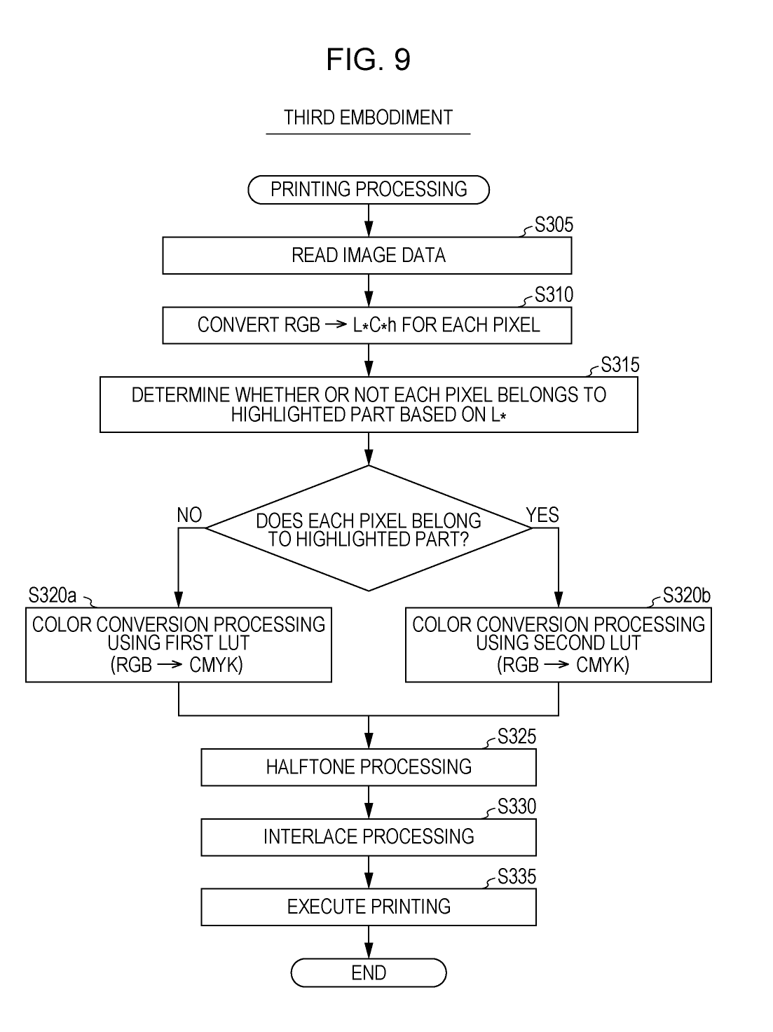

FIG. 9 is a flowchart of the printing processing according to the third embodiment. The processing to be firstly executed in Step S305 is the same processing in Step S105 in the printing processing according to the first embodiment shown in FIG. 2. Next, the color conversion unit 43 converts R, G, B of each pixel read in Step S105 into L*(brightness), C*(saturation), and h(hue angle) (Step S310). Such color space conversion can be performed using a known method.

The color conversion unit 43 determines whether or not each pixel belongs to the highlighted part Ah based on L* (Step S315). It is determined that the pixel whose L* value satisfies 80≦L*≦100 is a pixel belonging to the highlighted part Ah while the pixel whose L* value satisfies L*<80 is a pixel which does not belong to the highlighted part Ah.

The color conversion unit 43 performs the color conversion from R, G, B into C, M, Y, K on the pixels which do not belong to the highlighted part Ah with the use of the first LUT 62a (Step S320a). In addition, the color conversion unit 43 performs the color conversion from R, G, B into C, M, Y, K on the pixels belonging to the highlighted part Ah with the use of the second LUT 62b (Step S320b).

It is possible to avoid generation of significant differences in brightness between the pixels which belong to the highlighted part Ah and the pixels which do not belong to the highlighted part Ah, by performing the color conversion on the pixels which do not belong to the highlighted part Ah not with the use of the existing LUT but with the use of the first LUT 62a in which the differences in brightness per one gradation level in the highlighted part Ah are set to be large.

After the color conversion (Step S320a, S320b), the halftone processing (Step S325) and the interlace processing (Step S330) are executed in this order, and printing is then executed (Step S335). Step S325 to S335 are the same as the aforementioned Step S115 to S125 shown in FIG. 2.

In the aforementioned Step S320b, the color conversion is performed on the pixels belonging to the highlighted part Ah with the use of the second LUT 62b. Therefore, the increasing degree of C* of the color obtained in the actual printing with respect to the increase in the C* value of the input pixel belonging to the low saturation part Ac in the highlighted part Ah becomes greater than that of the pixels which do not belong to the low saturation part Ac. Accordingly, the brightness and the vividness per one gradation level are increased in the bright region with a faint color in the printed image as compared with the other regions. For this reason, the gradation reproducibility in the region with the faint color in the highlighted region of the printed image is enhanced.

The printer 20a according to the third embodiment as described above has the same effects as those by the printer 20 according to the first embodiment. In addition, the printer 20a uses as the LUT to be used in the color conversion for the pixels belonging to the low saturation part Ac the second LUT 62b set such that the differences in saturation of the ink color per one gradation level of the input pixels belonging to the low saturation part Ac become larger than those in saturation of the ink color per one gradation level of the input pixels which do not belong to the low saturation part Ac. The input pixels belonging to the low saturation part Ac are pixels for expressing relatively bright image regions with a faint color. Since the pixels with faint colors have low vividness, it is difficult to recognize the change in gradation. Therefore, it is possible to enhance the gradation reproducibility in the highlighted region of the printed image since the printer 20a of the third embodiment can perform printing such that the differences in saturation of the ink colors per one gradation level of pixels for which it is difficult to recognize the change in gradation become great. Accordingly, it is possible to further suppress the lowering of the gradation reproducibility in the highlighted region of the printed image even when the printing is performed by forming a layer of the color ink on the printing medium P with metallic luster.

The color conversion unit 43, the first LUT 62a, and the second LUT 62b in the third embodiment correspond to the color conversion unit in the above-described aspects.

### D. Modified Example

The components other than the components described in the independent claims are additional components from among the components in each of the above embodiments and can be appropriately omitted. In addition, the invention is not limited to the above embodiments and examples. It is possible to realize the invention in various manners within the scope of the gist. The following modifications can also be made, for example.

### D1. Modified Example 1

In the third embodiment, both the brightness and the saturation are adjusted (emphasized) in the highlighted region. However, another configuration is also applicable in which only saturation is adjusted (emphasized). In such a case, Step S215 as the LUT creating processing shown in FIG. 7 is omitted. Even with such a configuration, it is possible to suppress lowering of the gradation reproducibility in a region with a faint color in the highlighted region. According to this configuration, it is also possible to perform the color conversion processing with the use of the existing LUT instead of the first LUT 62a for the pixels which do not belong to the highlighted region. In the second embodiment, it is possible to employ a configuration in which both the brightness and the saturation or only the saturation is adjusted instead of the configuration in which only the brightness is adjusted.

In the first embodiment, the LUT 62 is used for all pixels as the LUT used in the color conversion processing. However, the invention is not limited thereto. For example, it is possible to employ another configuration in which the color conversion processing is performed with the use of the LUT 62 for the pixels belonging to the highlighted part Ah while the color conversion processing is performed with the use of the existing LUT for the pixels which do not belong to the highlighted region. Even with such a configuration, it is possible to suppress lowering of the gradation reproducibility in the highlighted region of the image.

### D2. Modified Example 2

In each embodiment, the image data ORG (R, G, B) is converted into L*C*h, and L* (brightness) or C* (saturation) is obtained in order to adjust the brightness or the saturation. However, the invention is not limited thereto. It is possible to obtain B (brightness) or S (saturation) by converting the image data not into L*C*h but into HSB (H: hue, S: saturation, B: brightness). Even with such a configuration, it is possible to obtain a new lattice point by adjusting the B value or the S value and then converting H, S, B into R, G, B. Since only the brightness is adjusted in the first embodiment, it is also possible to adjust L* (brightness) by converting R, G, B not into L*C*h but into L*a*b*.

### D3. Modified Example 3

In each embodiment, the color conversion LUTs (the LUT 62, the first LUT 62a and the second LUT 62b in the third embodiment) are so-called 3D LUTs which converts R, G, B into C, M, Y, K. However, the invention is not limited thereto. It is also possible to employ a multidimensional LUT of 4D or greater. For example, it is also possible to employ a 4D LUT which converts C, M, Y, K into C, M, Y, K. When such a 4D LUT is employed, C, M, Y, K is converted into L*C*h in Step S210 of the LUT creating processing, and L*C*h is converted into C, M, Y, K in Step S220. In addition, a known color conversion method between C, M, Y, K and L*C*h can be employed. In Step S106 in the printing processing according to the second embodiment, C, M, Y, K is converted into L*C*h, and L*C*h is then converted into C, M, Y, K in Step S108.

When the 4D LUT which converts C, M, Y, K into C, M, Y, K is employed, for example, it is also possible to convert C, M, Y, K into R, G, B and further convert R, G, B into H, S, B(or L*C*h) in Step S210 in the LUT creating processing. In addition, it is also possible to convert H, S, B (or L*C*h) into R, G, B and further convert R, G, B into C, M, Y, K in Step S220. Similarly, it is also possible to convert C, M, Y, K into R, G, B, further convert R, G, B into H, S, B (or L*C*h) in Step S106 in the printing processing, and convert H, S, B (or L*C*h) into R, G, B and further convert R, G, B into C, M, Y, K in Step S108 in the second embodiment.

### D4. Modified Example 4

In each embodiment, the brightness adjustment LUT 63 including setting contents shown in FIG. 4 is used for the adjustment of the brightness (L*). In the third embodiment, the saturation adjustment LUT 64 including the setting contents shown in FIG. 8 is used for the adjustment of the saturation (C*). However, the invention is not limited thereto. For example, it is also possible to employ a configuration in which a relational expression representing the curve in FIG. 4 and a relational expression shown in FIG. 8 are obtained in advance and the adjusted brightness (L*) and the adjusted saturation (C*) are determined and adjusted with the use of such relational expressions.

### D5. Modified Example 5

In each embodiment, the highlighted part Ah is a region in which L* satisfies 80≦L*≦100. However, the invention is not limited thereto. It is possible to employ an arbitrary range in which L* satisfies 50≦L*≦100 as the highlighted part Ah. In the third embodiment, the low saturation part Ac is a region in which C* satisfies 0≦C*≦20. However, the invention is not limited thereto. It is possible to employ an arbitrary range in which C* satisfies C* 30 as the low saturation part Ac.

### D6. Modified Example 6

In each embodiment, each of the values of C, M, Y, and K are determined by measuring the colors of the image, which have actually been printed, for reconstructing the LUT (Step S225). However, the invention is not limited thereto. For example, it is also possible to employ ink colors (C, M, Y, and K) associated with a reference point which is the closest to the new reference point in the existing LUT (the LUT including the reference point with L* before adjustment), as the ink colors (C, M, Y, and K) associated with the new reference point (R′, G′, B′) obtained in Step S220.

### D7. Modified Example 7

In each embodiment, the printer is an ink-jet printer. However, it is possible to use a laser printer and an offset printing apparatus instead of the ink-jet printer. Moreover, the printing medium P is an aluminum deposited sheet in each embodiment. However, the invention is not limited thereto. It is also possible to employ an aluminum deposited film obtained by depositing aluminum onto a resin film instead of a paper. Furthermore, it is possible to employ an arbitrary medium with metallic luster such as a metal (gold, silver, copper, stainless steel, or the like) deposited sheet other than aluminum, aluminum foil, gold leaf, or the like. In addition, it is also possible to employ an arbitrary recording medium with luster (recording medium having luster) such as a medium with pearly luster as well as a medium with metallic luster.

### D8. Modified Example 8

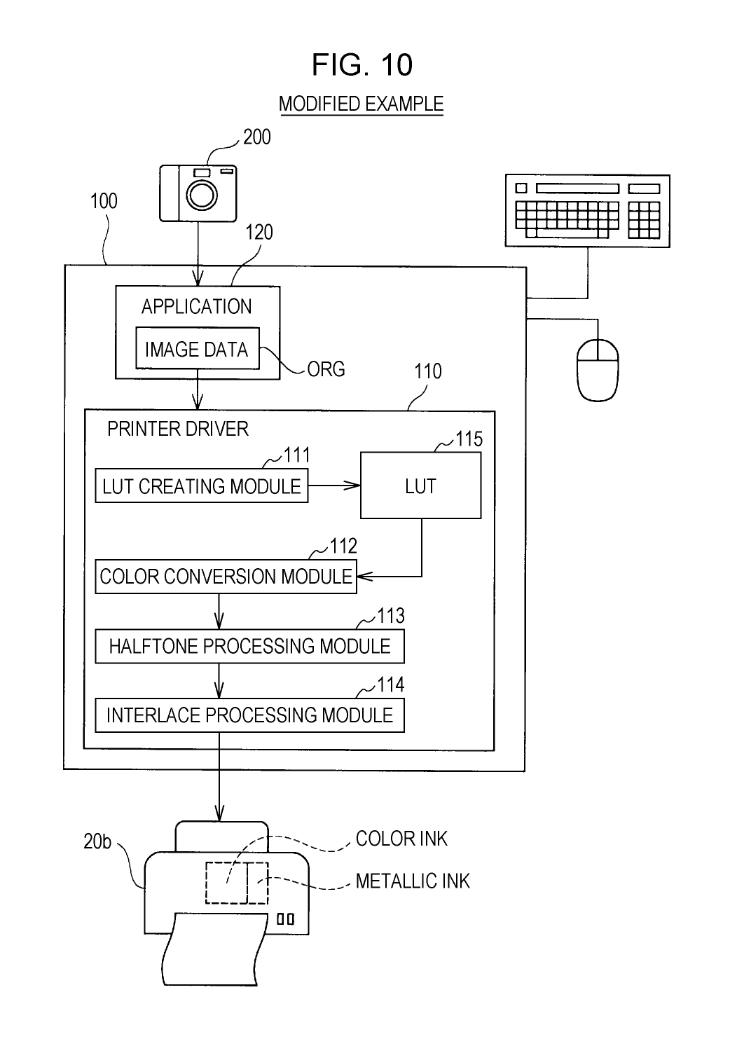

In each embodiment, examples are shown in which the invention is applied to a printer. However, the invention is not limited thereto. For example, the invention can also be applied to a computer connected to a printer. FIG. 10 is an explanatory diagram showing an application of the invention to a computer according to the modified example 8.

In FIG. 10, a computer 100 is connected to a printer 20b. In addition, the printer 20b is configured to print an image by discharging color ink onto the printing medium P in the same manner as the printer 20 according to the first embodiment.

A predetermined operating system is installed on the computer 100, and the application program 120 is operated under the operating system. The printer driver 110 is mounted on the operating system. The application program 120 inputs the image data ORG from the digital camera 200 via a circumferential device interface which is not shown in the drawing, for example. Then, the application program 120 outputs the image data ORG to the printer 20b via the printer driver 110. In addition, the image data ORG is the image data in the RGB format in the same manner as the image data ORG in each embodiment.

The printer driver 110 is provided with a LUT creating module 111, a color conversion module 112, a halftone processing module 113, an interlace processing module 114, and a LUT 115.

The LUT creating module 111 has the same functions as those of the LUT creating unit 42 according to the first embodiment shown in FIG. 1. In addition, the color conversion module 112 has the same functions as those of the color conversion unit 43 shown in FIG. 1. The halftone processing module 113 has the same functions as those of the halftone processing unit 44 shown in FIG. 1. The interlace processing module 114 has the same functions as those of the interlace processing unit 45 shown in FIG. 1.

In the computer 100 (printer driver 110) with such configurations, the aforementioned LUT creating processing is executed. Accordingly, the setting contents in the LUT 115 are the same as those in the LUT 62 according to the first embodiment shown in FIG. 1. Therefore, it is possible to achieve the same effects as those by the printer 20 according to the first embodiment, such as the suppression of lowering of the gradation reproducibility in the highlighted region of the printed image, by executing printing by the printer 20b based on the image data after the color conversion with the use of such a LUT 115. In addition, the computer 100 (printer driver 110) in the aforementioned modified embodiment 8 corresponds to the printing control apparatus in the above-described aspects. It is also possible to apply the invention not only to the printer and the computer (printer driver) as described above but also to a color conversion method, a color conversion program, a recording medium, a color conversion LUT, a method of creating a color conversion LUT, a printed material, and the like.

### D9. Modified Example 9

In each embodiment, a part of the configurations realized by the software may be replaced with hardware. On the other hand, a part of the configurations realized by the hardware may be replaced with software.

What is claimed is:

1. A printing apparatus which prints an image forming a layer containing a colorant on a recording medium having luster, comprising:
a color conversion unit which converts a color of the image into a printed color expressed the colorant such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image.

2. The printing apparatus according to claim 1,
wherein the color conversion unit converts the color of the image into the printed color with the use of a color conversion LUT which sets the degree of change in brightness with respect to the gradation change for the pixels with the index values which belong to the highlighted part to be larger than that for the pixels with the index values which do not belong to the highlighted region, among the pixels constituting the image.

3. The printing apparatus according to claim 1,
wherein the color conversion unit includes:
a brightness adjustment unit which sets the degree of change in brightness with respect to the gradation change for the pixels with index values which belong to the highlighted region to be larger than that for the pixels with index values which do not belong to the highlighted region, among the pixels constituting the image;
a color conversion LUT which associates the color of the image with the printed color; and
a conversion unit which converts the color of the image which has been adjusted by the brightness adjustment unit into the printed color with the use of the color conversion LUT.

4. A printing apparatus which prints an image by forming a layer containing a colorant on a recording medium having luster, comprising:
a color conversion unit which converts a color of an image into a printed color expressed by the colorant such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image.

5. The printing apparatus according to claim 4,
wherein the color conversion unit converts the color of the image into the printed color with the use of a color conversion LUT which sets the degree of change in saturation with respect to the gradation change for the low saturation pixels to be larger than that for the pixels with the index values which do not belong to the highlighted region, among the pixels constituting the image.

6. The printing apparatus according to claim 4,
wherein the color conversion unit includes:
a saturation adjustment unit which sets the degree of change in saturation with respect to the gradation change for the low saturation pixels to be larger than that for the pixels with index values which do not belong to the highlighted region, among the pixels constituting the image;
a color conversion LUT which associates the color of the image with the printed color; and
a conversion unit which converts the color of the image which has been adjusted by the saturation adjustment unit into the printed color with the use of the color conversion LUT.

7. A printing control apparatus which controls a printing apparatus which prints an image by forming a layer containing a colorant on a recording medium having luster, the printing control apparatus comprising:
a color conversion unit which converts a color of an image into a printed color expressed by the colorant such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image.

8. A printing control apparatus which controls a printing apparatus which prints an image by forming a layer containing a colorant on a recording medium having luster, the printing control apparatus comprising:
a color conversion unit which converts a color of an image into a printed color expressed by the colorant such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image.

9. A color conversion method by which a color of an image is converted into a printed color expressed by a colorant used in a printing apparatus, the method comprising:
converting a color of an image into a printed color such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image,
wherein the printing apparatus is capable of printing the image by forming a layer containing the colorant on a recording medium having luster,
wherein the above step are executed by a processor.

10. A color conversion method by which a color of an image is converted into a printed color expressed by a colorant used in a printing apparatus, the method comprising:
converting a color of an image into a printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image,
wherein the printing apparatus is capable of printing the image by forming a layer containing the colorant on a recording medium having luster,
wherein the above step are executed by a processor.

11. A computer readable storage medium storing computer program by which a color of an image is converted into a printed color expressed by a colorant used in a printing apparatus, the program causing a computer to execute:
converting a color of an image into a printed color such that a degree of change in brightness with respect to a gradation change for pixels belonging to a highlighted part in which index values relating to the brightness are equal to or greater than a predetermined value is greater than that for pixels with index values which do not belong to the highlighted part, among the pixels constituting the image,
wherein the printing apparatus is capable of printing the image by forming a layer containing the colorant on a recording medium having luster.

12. A computer readable storage medium storing computer program by which a color of an image is converted into a printed color expressed by a luster agent and a colorant used in a printing apparatus, the program causing a computer to execute:
converting a color of an image into a printed color such that a degree of change in saturation with respect to a gradation change for low saturation pixels, which are pixels belonging to a highlighted part in which index values relating to brightness are equal to or greater than a predetermined value, whose saturation is equal to or less than a predetermined value, is larger than that for pixels with index values which do not belong to the highlighted part, among the pixels constituting the image,
wherein the printing apparatus is capable of printing the image by forming a layer containing the colorant on a recording medium having luster.
